(19) United States
(12) Patent Application Publication
(10) Pub. No.: US 2008/0055220 A1
(43) Pub. Date: Mar. 6, 2008

(54) DISPLAY CONTROL DEVICE, SEMICONDUCTOR INTEGRATED CIRCUIT DEVICE AND MOBILE TERMINAL DEVICE

(76) Inventors: Yuri AZUMA, Tokyo (JP); Yasuyuki KUDO, Tokyo (JP); Tatsuya ISHII, Tokyo (JP)

Correspondence Address: MILES & STOCKBRIDGE PC, 1751 PINNACLE DRIVE, SUITE 500, MCLEAN, VA, 22102-3833, US

(21) Appl. No.: 11/841,879

(22) Filed: Aug. 20, 2007

(30) Foreign Application Priority Data
Sep. 5, 2006 (JP) 2006-239968

(51) Int. Cl. G09G 3/36

(52) U.S. Cl. 345/89

(57) ABSTRACT

Tone modification of pixel data is performed, minimizing dummy cycles inserted by a host device that transfers the pixel data. A modification circuit capable of modifying tone values of pixel data sequentially transferred from an external entity comprises a shift circuit for shifting pixel data in sync with an operational clock, a parallel latch circuit for latching in parallel shift outputs for a plurality of serial pixels of pixel data passing through the shift circuit, an arithmetic circuit for arithmetic processing using the pixel data for the serial pixels latched in the parallel latch circuit, while synchronizing with shift actions of the shift circuit, and modifying an intermediate shift output of the shift circuit, and a selector that selects output of the last shift stage of the shift circuit instead of output of the arithmetic circuit for a period when a result of modification is obtained by the modification circuit, using the pixel data latched in the parallel latch circuit for pixels not placed on a same line in a transfer direction depending on the display size.

### CROSS-REFERENCE TO RELATED APPLICATIONS

The disclosure of Japanese Patent application No. 2006-239968 filed on Sep. 5, 2006 including the specification, drawings and abstract is incorporated herein by reference in its entirety.

### BACKGROUND OF THE INVENTION

The present invention relates to a technique for modifying tone values of pixel data sequentially transferred from an external entity in accordance with display size, the technique being incorporated in, inter alia, a semiconductor integrated circuit for control of driving of a liquid crystal display device and a mobile terminal device such as a mobile phone and being effectively used for edge enhancement by tone modification of image data which is written into, for example, a display data frame buffer.

A technique for edge enhancement by tone modification of image data has been provided. A liquid crystal display device adapted to generate a modify signal for modifying luminance based on a relation defined depending on an input tone signal of an (N−1)th frame and an input tone signal of a N-th frame and modify the input tone signal of the N-th frame using the modify signal is described in Patent Document 1. Edge enhancement can be carried out by emphasizing the differences between the tone value of a pixel in a focused position and the tone values of its preceding and following pixels in a sequence of pixels. To emphasize the tone of the focused pixel, it has to wait until data for the preceding and following pixels with respect to the focused pixel has been transferred and received. Upon receiving the data, operations for edge enhancement are performed in multiple cycles in sync with a clock. For example, the following steps are serially performed: smoothing with the tone value of the focused pixel and the tone values of its preceding and following pixels, evaluating a difference between the smoothed tone and the tone of the focused pixel, and adding the difference to the tone of the focused pixel. To perform this series of steps in a pipeline fashion, it is necessary to transfer the data of the focused pixel in a midstream of or a tail portion of a pipeline in sync with the operation cycles. If this series of steps is performed in a pipeline fashion in sync with the clock, edge-enhanced pixel data can be obtained from input pixel data by serially streaming input pixel data into the pipeline for edge enhancement processing.

### [Patent Document 1]

### Japanese Unexamined Patent Publication No. 2002-82657

### SUMMARY OF THE INVENTION

For edge enhancement processing in a pipeline fashion as described above, it is undesirable to have an effect on different lines of pixel data to be displayed. For example, it must be avoided that data for pixels to be processed by the above smoothing be placed over two lines of display. It is thus necessary to insert multiple dummy cycles each time changing one line of display of pixel data transferred to another line, so that at least data for the pixels to be processed by smoothing falls on a same line of display. Generally, the source of transfer of pixel data issues the dummy cycles, because the dummy cycles relate to transfer cycles. When a host device transfers such pixel data by a parallel interface, it must execute an instruction, for example, for issuing a dummy write access cycle, each time inserting a dummy cycle. Thereby, a problem of increasing the burden of the host device was found. Increase in the burden of the host device is not only a problem with the parallel interface, but also occurs when receiving a transfer of pixel data using other interfaces such as a serial interface.

Objects of the present invention is to provide a display control device allowing for tone modification of pixel data, minimizing dummy cycle insertions by the host device which is the source of transfer of pixel data; and to provide a semiconductor integrated circuit and a mobile terminal device employing the above display control device.

The above-noted objects and other objects and novel features of the invention will become apparent from the description of the present specification and the accompanying drawings.

Typical aspects of the invention disclosed in the present application will be summarized below.

[1] A display control device (10) according to an aspect of the invention includes a modification circuit (70, 70A) capable of modifying tone values of pixel data sequentially transferred from an external entity in accordance with display size. The modification circuit comprises a shift circuit (71, 71A) having a plurality of stages for shifting sequentially transferred pixel data in sync with an operational clock; a parallel latch circuit (72, 72A) for latching in parallel shift outputs for a plurality of serial pixels of pixel data passing through said shift circuit; an arithmetic circuit (73, 73A, 74, 74A, 75) for arithmetic processing using the pixel data for the serial pixels latched in the parallel latch circuit, while synchronizing with shift actions of the shift circuit, and modifying an intermediate shift output of the shift circuit according to the arithmetic processing result; a selector (76) for selecting output of a last shift stage of the shift circuit or output of the arithmetic circuit; and a selection control circuit (79, 79A) generating a control signal for allowing the selector to select the output of the last shift stage of the shift circuit for a period when a result of modification is obtained by the modification circuit, using the pixel data latched in the parallel latch circuit for pixels not placed on a same line in a transfer direction depending on the display size.

According to this aspect, the selector is caused to select the output of the last shift stage of the shift circuit for successive clock cycles in which the pixel data latched in the parallel latch circuit is not for serial pixels existing on a same line in the transfer direction depending on the display size. Thus, it can be inhibited that pixel data is modified by a result of arithmetic processing on serial pixel data not placed on a same line of the transfer direction. In other words, the result of arithmetic processing performed using the pixel data latched in the parallel latch for the above period is ignored and, therefore, it is not required to insert dummy cycles deliberately to prevent pixel data from being latched for the period. Consequently, tone modification of pixel data can be carried out, minimizing dummy cycles inserted by the host device which is the source of transfer of pixel data.

In one particular aspect of the invention, when the parallel latch circuit is configured to latch pixel data for a maximum of three pixels, the selection control circuit (79) causes the selector to select pixel data for a pixel in an end position of a line in the transfer direction depending on the display size from the last shift stage of the shift circuit.

In another particular aspect of the invention, when the parallel latch circuit is configured to latch pixel data for a maximum of five pixels, the selection control circuit (79A) causes the selector to select pixel data for a pixel in an end position and its neighboring pixel on a line in the transfer direction depending on the display size from the last shift stage of said shift circuit.

In a further particular aspect of the invention, the display control device includes a first control register (VSA, VEA, HSA, HEA) for specifying the display size in vertical and horizontal directions. The selection control circuit judges the end pixel position in the transfer direction depending on the display size, based on values set in the first control register. Control operation by the selection control circuit can be attained easily.

In yet another particular aspect of the invention, the arithmetic circuit performs first arithmetic processing for smoothing the pixel data for serial pixels latched in the parallel latch circuit, second arithmetic processing for calculating differential data from a difference between smoothed data and pixel data obtained from an intermediate shift output of the shift circuit, and third arithmetic processing for adding the differential data to pixel data obtained from a next-stage intermediate shift output of the shift circuit. Edge enhancement by tone modification of pixel data can be carried out easily.

In a further particular aspect of the invention, the shift circuit comprises five serial shift stages (LT1 to LT5) and the parallel latch circuit latches in parallel serial intermediate shift outputs of a first shift stage of the shift circuit for three cycles of the operational clock. The arithmetic circuit comprises a first arithmetic processing circuit (73) which takes parallel inputs of the pixel data for three pixels latched in the parallel latch circuit and performs the first arithmetic processing in one cycle of the operational clock, a second arithmetic circuit (74) which receives output of the first arithmetic processing circuit and an intermediate shift output of a third shift stage of the shift circuit and performs the second arithmetic processing in one cycle of the operational clock, and a third arithmetic circuit (75) which receives output of the second arithmetic processing circuit and an intermediate shift output of a fourth shift stage of the shift circuit and performs the third arithmetic processing in one cycle of the operational clock. Edge enhancement by tone modification of pixel data can be carried out easily.

In yet another particular aspect of the invention, the selection control circuit causes the selector to select pixel data in an end pixel position in the transfer direction depending on the display size, as output of the last shift stage of the shift circuit, and causes the selector to select output of the third arithmetic circuit for other pixel positions.

In a further particular aspect of the invention, the display control device includes a second control register (AVST), wherein weighting that is applied to pixel data that is used for smoothing is determined depending on a value set in the second control register. The display control device further includes a third control register (DTHH, DTHL), wherein an upper limit and a lower limit of a difference that is used to obtain differential data are determined depending on values set in the third control register. The display control device further includes a fourth control register (ADST), wherein weighting that is applied to differential data to be added is determined depending on a value set in the fourth control register. By changing the settings in these control registers, optimal edge enhancement depending on image type can be performed easily.

[2] A semiconductor integrated circuit according to another aspect of the invention comprises external terminals (TML1) for host interface; a host interface circuit (20) coupled to the external terminals for host interface; a display control circuit (21) coupled to the host interface circuit; and external terminals (TML2) for display drive coupled to the display control circuit. The host interface circuit comprises at least one of a first serial interface circuit (25) for serial data input and output in a differential manner, a parallel interface circuit (33), and any other interface circuit, wherein an interface circuit is selected for use as the interface with a host device according to a host interface mode setting state. The display control circuit comprises a display data memory (43) capable to be used as a frame buffer of display data; and a modification circuit (70) capable of modifying tone values of pixel data to be stored in the display data memory. The modification circuit comprises a shift circuit having a plurality of stages for shifting pixel data sequentially transferred from the host interface circuit in accordance with display size in sync with an operational clock; a parallel latch circuit for latching in parallel shift outputs for a plurality of serial pixels of pixel data passing through the shift circuit; an arithmetic circuit for arithmetic processing using the pixel data for the serial pixels latched in the parallel latch circuit, while synchronizing with shift actions of the shift circuit, and modifying an intermediate shift output of the shift circuit according to the arithmetic processing result; a selector for selecting output of a last shift stage of the shift circuit or output of the arithmetic circuit; and a selection control circuit allowing the selector to select the output of the last shift stage of the shift circuit for a period when a result of modification is obtained by the modification circuit, using the pixel data latched in the parallel latch circuit for pixels not placed on a same line in a transfer direction depending on said display size.

According to this aspect, tone modification of pixel data can be carried out, minimizing dummy cycles inserted by the host device which is the source of transfer of pixel data, because the same modification circuit as described above is employed.

In one particular aspect of the invention, the host interface circuit comprises the first serial interface circuit and the first serial interface circuit, when selected for use as the interface with the host device, generates the operational clock in response to reception of pixel data packets. A data packet having dummy data written is added in the end of a series of the data packets for one frame.

When the parallel interface circuit is selected for use as the interface with the host device, the parallel interface circuit generates the operational clock in response to level change of a write strobe signal which is one of parallel interface control signals supplied together with pixel data externally of the semiconductor integrated circuit. Tone modification of pixel data can be carried out, minimizing dummy cycles inserted in either case where the parallel interface is used, or where the high-speed serial interface is used for the interface with the host device.

In a further particular aspect of the invention, the any other interface circuit comprises an RGB image input interface circuit for inputting timing control signals for rendering data that is input via the parallel interface into the frame buffer. As the timing control signals, a data enable signal which indicates that valid data is present, a horizontal synchronization signal, a vertical synchronization signal, and a dot clock which specifies timing for taking in data are input. The RGB image input interface circuit supplies the dot clock input as the operational clock to the modification circuit.

[3] A mobile terminal device according to a further aspect of the invention comprises a first casing half (17) and a second casing half (15) foldably coupled to the first casing half via a hinge member (16). The first casing half comprises the host device (5). The second casing half comprises a liquid crystal display drive controller (10) interfaced with the host device via a plurality of signal lines and a liquid crystal display (11) whose display operation is controlled by the liquid crystal display drive controller. The signal lines go through the hinge member. The liquid crystal display drive controller is formed in a semiconductor integrated circuit comprising external terminals for host interface; a host interface circuit coupled to the external terminals for host interface; a display control circuit coupled to the host interface circuit; and external terminals for display drive coupled to the display control circuit. The host interface circuit comprises a first serial interface circuit for serial data input and output in a differential manner; a parallel interface circuit; and any other interface circuit, wherein an interface circuit is selected for use as the interface with the host device according to a host interface mode setting state. The display control circuit comprises a display data memory capable to be used as a frame buffer of display data; and a modification circuit capable of modifying tone values of pixel data to be stored in the display data memory. The modification circuit comprises a shift circuit having a plurality of stages for shifting pixel data sequentially transferred from the host interface circuit in accordance with display size in sync with an operational clock; a parallel latch circuit for latching in parallel shift outputs for a plurality of serial pixels of pixel data passing through the shift circuit; an arithmetic circuit for arithmetic processing using the pixel data for the serial pixels latched in said parallel latch circuit, while synchronizing with shift actions of the shift circuit, and modifying an intermediate shift output of the shift circuit according to the arithmetic processing result; a selector for selecting output of a last shift stage of the shift circuit or output of the arithmetic circuit; and a selector allowing selection of the output of the last shift stage of the shift circuit for a period when a result of modification is obtained by said modification circuit, using the pixel data latched in said parallel latch circuit for pixels not placed on a same line in a transfer direction depending on said display size.

According to this aspect, tone modification of pixel data can be carried out, minimizing dummy cycles inserted by the host device which is the source of transfer of pixel data, because the same modification circuit as described above is employed.

In one particular aspect of the invention, when the first serial interface circuit is selected for use as the interface with the host device, the first serial interface circuit generates the operational clock in response to reception of pixel data packets. A data packet having dummy data written is added in the end of a series of the data packets for one frame.

When the parallel interface circuit is selected for use as the interface with the host device, the parallel interface circuit generates the operational clock in response to level change of a write strobe signal which is one of parallel interface control signals supplied together with pixel data from the host device.

Effect that will be achieved by typical aspects of the invention disclosed in the present application will be briefly described below.

It is thus possible to provide a display control device capable of modifying tone values of pixel data, minimizing dummy cycles inserted by the host device which is the source of transfer of pixel data and to further provide a semiconductor integrated circuit and a mobile terminal device employing the above display control device.

### BRIEF DESCRIPTION OF THE DRAWINGS

FIG. 1 is a block diagram showing an example of a modification circuit employed in a liquid crystal display drive controller.

FIG. 2 is a block diagram showing a schematic structure of a mobile phone.

FIG. 3 is an illustration for showing a path of transfer of a display command and display data in the mobile phone shown in FIG. 2.

FIG. 4 is a block diagram illustrating a detailed structure of a liquid crystal display drive controller.

FIG. 5 is an illustration depicting a principle of how to modify tone values for edge enhancement by the modification circuit 70.

FIG. 6 provides a list of values of control registers for edge enhancement.

FIG. 7 is an illustration depicting a relationship between a frame buffer area and address registers which are used for addressing the points that define the area.

FIGS. 8A through 8H are illustrations depicting a plurality of directions and sequences in which pixel data is transferred to the frame buffer.

FIG. 9 is an operation timing chart of the modification circuit of FIG. 1.

FIG. 10 is an operation timing chart presented as a comparison example for a case where a selector 76 in FIG. 1 is not employed to inhibit edge enhancement using pixel data for pixels placed over two lines of transfer.

FIG. 11 is an operation timing chart of the modification circuit configured to complete arithmetic processing in two clock cycles.

FIG. 12 is an operation timing chart of the modification circuit configured to complete arithmetic processing in two clock cycles and with a parallel latch circuit adapted to latch five pixel data.

FIG. 13 is a block diagram illustrating a structure of the modification circuit adapted for the operation of FIG. 12.

FIG. 14 is an illustration depicting window setup in any position within a maximum area.

FIG. 15 is a timing chart illustrating a modification operation for data size per line of transfer smaller than in the operational embodiment of FIG. 9.

FIG. 16 is a diagram illustrating a data flow including a dummy write data packet to be added in the end of a frame in a case where a high-speed serial interface circuit generates a write clock in response to reception of pixel data packets.

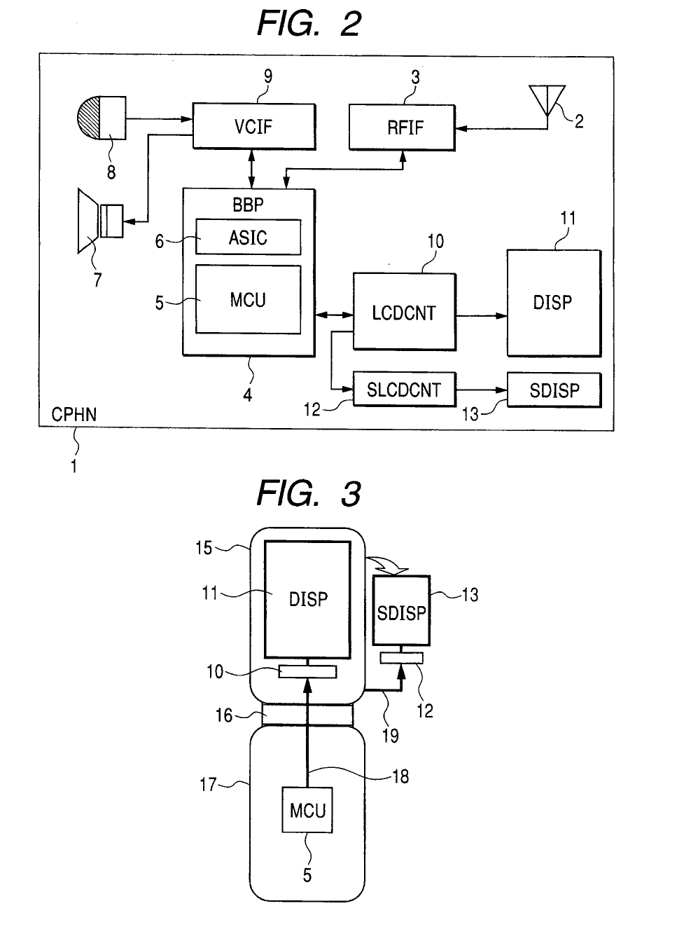

### DETAILED DESCRIPTION OF THE PREFERRED EMBODIMENTS

<<Mobile phone>> FIG. 2 illustrates an example of a mobile phone 1. A radio band signal received by an antenna 2 is passed to a radio frequency interface (RFIF) section 3. The received signal is converted into a lower frequency signal by the RFIF section 3, demodulated, and converted into a digital signal which is supplied to a baseband section (BBP) 4. The baseband section 4 performs codec processing using a microcomputer (MCU) 5 or the like, decrypts the received digital signal, and performs an error correction on the signal. The BBP then separates the received signal data into control data required for communication and communication data such as compressed voice data, using an application specific semiconductor device (ASIC) 6. The control data is passed to the MCU 5 and the MCU 5 performs communication protocol processing or the like on the control data. The voice data extracted by channel codec processing is decompressed by using the MCU 5 and a voice interface circuit (VCIF) 9 converts the decompressed voice data into an analog signal which is reproduced as voice by a speaker 7. In transmitting operation, a voice signal input from a microphone 8 is converted into a digital signal by the VCIF circuit 9. The digital signal is filtered and converted into compressed voice data by using the MCU 5 or the like. The ASIC 6 combines the compressed voice data and control data from the MCU 5 into a transmission data string and adds an error correction and detection code and an encryption code to the data string by using the MCU 5, thus generating transmission data. The transmission data is modulated by the RFIF section 3 and the modulated transmission data is converted into an RF signal which is, after amplified, transmitted by the antenna 2 as a radio signal.

The MCU 5 issues a display command, display data, and the like to a liquid crystal display drive controller (LCDCNT) 10. The LCDCNT 10 performs control of displaying an image on a liquid crystal display 11 according to the issued display command and display data or transfers the display command and display data to a sub liquid crystal display drive controller (SLCDCNT) 12 for control to enable displaying an image on a sub liquid crystal display (SDISP) 13. The MCU 5 comprises circuit units such as a central processing unit (CPU) and a digital signal processor (DSP). The MCU 5 may be configured to have separate processors: a baseband processor dedicated to baseband processing tasks for communication and an application processor dedicated to additional function control tasks such as display control and security control. Although not restrictive, in the illustrated embodiment, the LCDCNT 10, SLCDCNT 12, ASIC 6, and MCU 5 are configured as independent semiconductor devices, respectively. The MCU is assumed as a host device to the LCDCNT 10.

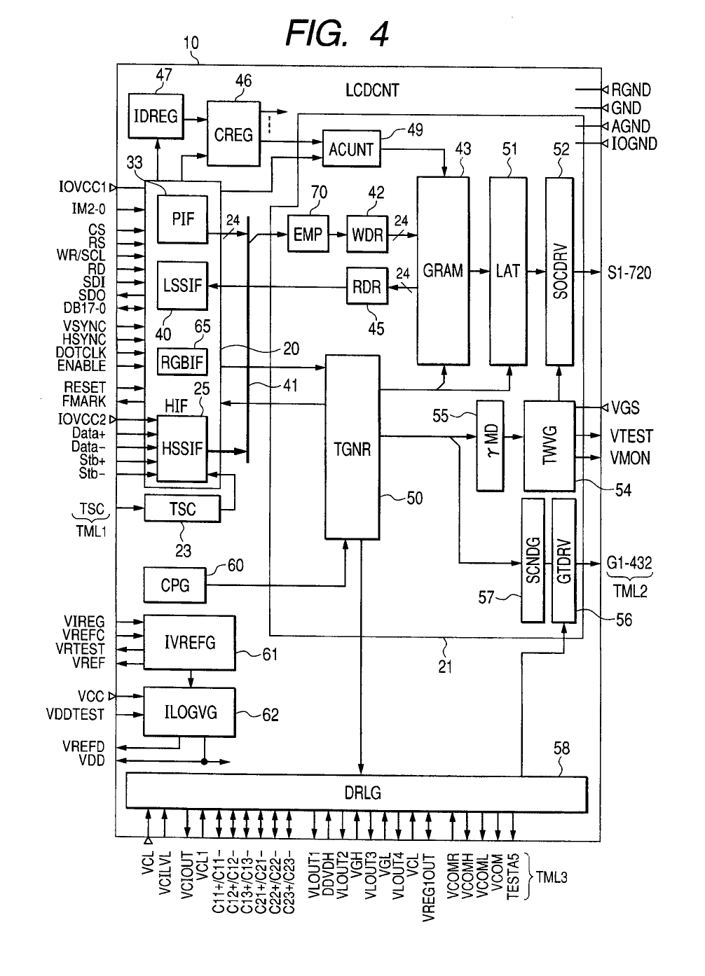

FIG. 3 shows a path of transfer of a display command and display data in the mobile phone shown in FIG. 2. Here, the mobile phone has a second casing half 15 and a first casing half 17 foldably coupled to the second casing half 15 via a hinge member 16. The second casing half 15 includes the LCDCNT 10 and the SLCDCNT 12 as well as the liquid crystal display 11 and the sub liquid crystal display 13 which are driven by these controllers. In FIG. 3, it should be appreciated that the SLCDCNT 12 and SDISP 13 are placed on the reverse side of the second casing half 15. The first casing half 17 includes the MCU 5 as the host device. It also includes a plurality of signal lines 18 coupling the LCDCNT 10 and the MCU 5. The signal lines 18 go through the hinge member 16. Some of the signal lines 18 are differential signal lines for information transfer by high-speed serial interfacing. The SLCDCNT 12 is coupled to the LCDCNT 10 by a plurality of signal lines 19. A display command and display data are parallel transferred to the SLCDCNT 12 through the signal lines 19. High-speed serial interfacing with low amplitude between the LCDCNT 10 and the MCU 5 can be implemented by using the differential signal lines. These lines can provide a required transfer rate even with fewer signal lines than the bus signal lines 19 for parallel interfacing. As a result, the signal lines wired between the LCDCNT 10 and the MCU 5 can be lessened and a risk of breaking of the signal lines 18 for aging, as the casing half is folded and unfolded on the hinge member 16 habitually, can be reduced significantly. Since the signal lines 19 do not go through the hinge member 16, they can convey a display command and display data by parallel transfer.

<<Liquid crystal display drive controller>> FIG. 4 illustrates a detailed structure of the liquid crystal display drive controller (LCDCNT) 10. The LCDCNT 10 includes external terminals TML1 for host interface, a host interface circuit 20 coupled to the external terminals TML1 for host interface, a display control circuit 21 coupled to the host interface circuit 20, external terminals TMK2 for display drive coupled to the display control circuit 21, and other components. The display control circuit 21 is provided with a modification circuit (EMP) 70 that can modify tone values of pixel data which is transferred in accordance with display size. This modification circuit 70 is used for edge enhancement by tone modification of image data which is stored into a frame buffer of a display data memory (GRAM) 43.

The host interface circuit 20 includes a high-speed serial interface circuit (HSSIF) 25 for serial data input and output in a differential manner, a parallel interface circuit (PIF) 33, a clock-synchronized serial interface circuit (LSSIF) 40 for clock-synchronized serial interfacing at a lower speed than the HSSIF 25, an RGB image input interface circuit (RGBIF) 65, and an interface control signal generating circuit (IFSG) 22.

The high-speed serial interface circuit (HSSIF) 25 performs serial interfacing with differential signal lines. Two differential data terminals data+ and data− and two differential strobe signal terminals Stb+ and Stb− are assigned to the high-speed serial interface. A specific transfer protocol for the high-speed serial interface is not described restrictively herein. However, for example, the transmitter side of the interface sends data through the differential data terminals data+ and data− in sync with edge changes of clock signals present at the differential strobe signal terminals Stb+ and Stb− and the receiver side takes data present at the differential data terminals data+ and data− for each fixed period of clock signals present at the differential strobe signal terminals Stb+ and Stb−. Determining whether a signal is “1” or “0” may be made depending on a direction of a differential current. Preferably, transfer rate is set at a high rate, e.g., 100 Mbps to 400 Mbps, and signal amplitude is set at a low amplitude, e.g., 300 mV.

Parallel data terminals DB17-0, a chip select terminal CS, a register select terminal RS, a write terminal WR, and a read terminal RD are assigned to the parallel interface circuit 33. Although not restrictive, an access control signal that is used for access to an external bus of a Z80 microprocessor is considered to be used for the parallel interface assumed herein. To the above terminals CS, RS, WR, and RD, a chip select signal, a register select signal, a write signal, and a read signal are supplied as interface control signals for the parallel interface from the MCU 5.

The clock-synchronized serial interface circuit 40 serves for serial input and output of data, using a serial input terminal SDI and a serial output terminal SDO. The amplitude of a signal that is transferred through theses terminals SDI, SDO is as high as about 1.5 to 3.3 V and the transfer rate is low.

The RGB image input interface circuit (RGBIF) 65 is a circuit that inputs timing control signals for rendering image data which is input via the parallel interface circuit 33 into the frame buffer. The timing control signals are used when, for example, moving image data sent from the host device is received and written into the frame buffer, and displaying the moving image is controlled with the display drive circuit 21. The timing control signals which are input by the RGB image input interface circuit 65 are a data enable signal ENABLE which indicates that valid data is present, a horizontal synchronization signal HSYNC, a vertical synchronization signal VSYNC, and a dot clock DOT CLK which specifies timing for taking in data.

For input and output of a command and display data from/to the MCU 5 as the host device, the parallel interface circuit 33, the high-speed serial interface circuit 25, or the low-speed serial interface circuit 40 can be used. Which interface is used is determined depending on the pulled-up or pulled down state of each mode terminal IM2-0.

Packets in a predetermined format are used for transfer of a command and data between the MCU 5 and the host interface circuit 20. If the high-speed interface circuit is used as the host interface, it receives a command and display data from the differential data terminals data+ and data−. If the parallel interface is used as the host interface, it receives a command and display data from the data input/output terminals DB17-0. When the low-speed serial interface is used as the host interface, it receives a command and display data from the serial data input terminal SDI. If the parallel interface is used as the interface with the MCU 5, the chip select signal CS, write signal WR, read signal RD, and register select signal RS are input from the host device 5. The chip select signal CS means a chip selection when the signal level is low. The write signal WR is defined herein as a write strobe signal that means writing when the signal level is low. The read signal RF is defined herein a read strobe signal that means reading when the signal level is low.

When host interface circuit 20 receives a command packet from the MCU 5, the interface stores address information received by the packet into an index register (IDREG) 47. The index register 47 generates a register select signal or the like by decoding the command address stored therein. Command data received by the packet is transferred to a command data register array (CREG) 46. The command register array 46 includes a large number of command data registers mapped to predetermined addresses. A command data register into which the received command is to be stored is selected by the register select signal that is output from the index register 47. The command data latched into the selected command data register is transferred as an instruction or control data to the appropriate circuit portion for control of internal operation. It is also possible to write a command directly into a command data register designated by the address information of a command packet, according to the packet header information. If the parallel interface is selected, the direct writing of a command into a command data register is indicated by a high level of the register select signal RS.

When the host interface circuit 20 receives a data packet from the MCU 5, the interface sets address information into an address counter 49, according to the packet header information. The interface transfers write data via the modification circuit (EMP) 70 to a write data register (WDR) 42 or takes input of read data from a read data register (RDR) 45. Or the interface sets control data into a control register designated by the address information, according to the contents of the packet header information. The address counter 49 performs an increment operation or the like in accordance with the contents of the command data register to which the address information refers and performs addressing within the display data memory (GRAM) 43. At this time, if the command data specifies a write access operation to the display data memory 43, the data contained in the data packet is transferred from a bus 41 via the modification circuit 70 to the write data register (WDR) 42 and stored into the display data memory (GRAM) 43 at precise timing. Storing display data is performed, for example, in units of display frames or the like. If the command data specifies a read access operation from the display data memory 43, data stored in the display data memory 43 is read to the read data register (RDR) 45 from which the data can be transferred to the MCU 5. When the command data register receives a display command, a read operation from the display data memory 43 is performed in sync with displaying timing. Timing control of reading and displaying is performed by a timing generator (TGNR) 50. Display data which has been read from the display data memory 43 in sync with displaying timing, is latched into a latch circuit (LAT) 51. The latched data is supplied to a source driver (SOCDRV) 52. The liquid crystal display 11 whose driving is controlled by the liquid crystal display drive controller 10 consists of a dot matrix type liquid crystal panel comprising thin film transistors (TFTs). The liquid crystal panel further includes a large number of source electrodes as signal electrodes and a large number of gate electrodes as scanning electrodes for driving pixels. The source driver (SOCDRV) 52 drives the source electrodes of the liquid crystal display 11 via drive terminals S1-720. The drive levels of the drive terminals S1-720 are determined by tone voltages generated by a tone voltage generating circuit (TWVG) 54 and applied to these terminals. The tone voltages can be gamma-modified by a gamma modification circuit (γMD) 55. A canning data generating circuit (SCNDG) 57 generates data for scanning in sync with scanning timing from the timing generator 50. The data for scanning is transferred to a gate driver (GTDRV) 56. The gate driver 56 drives the gate electrodes of the liquid crystal display 11 via drive terminals G1-432. The drive levels of the drive terminals G1-432 are determined by drive voltages generated by a liquid crystal display drive level generating circuit (DRLG) 58 provided with charge pumping circuits and applied to these terminals. A plurality of external terminals TML3 attached to the DRLG 58 are external terminals such as capacitor elements for constituting the charge pumping circuits.

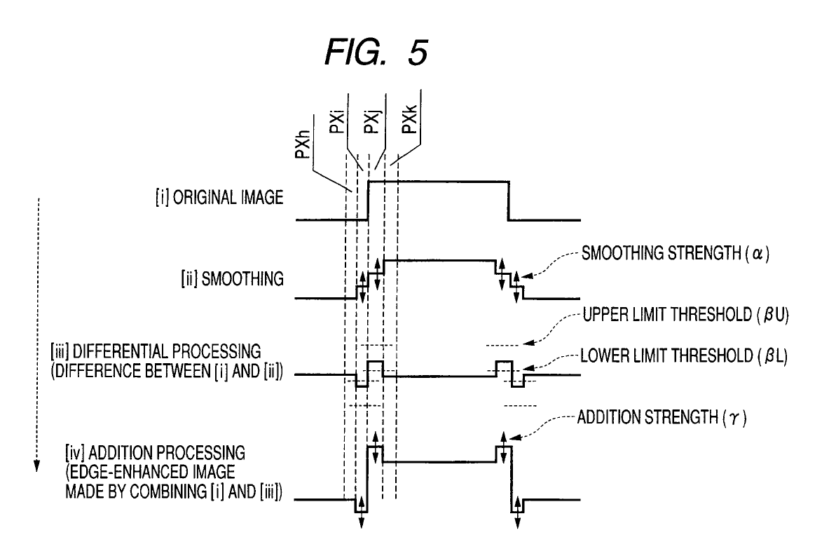

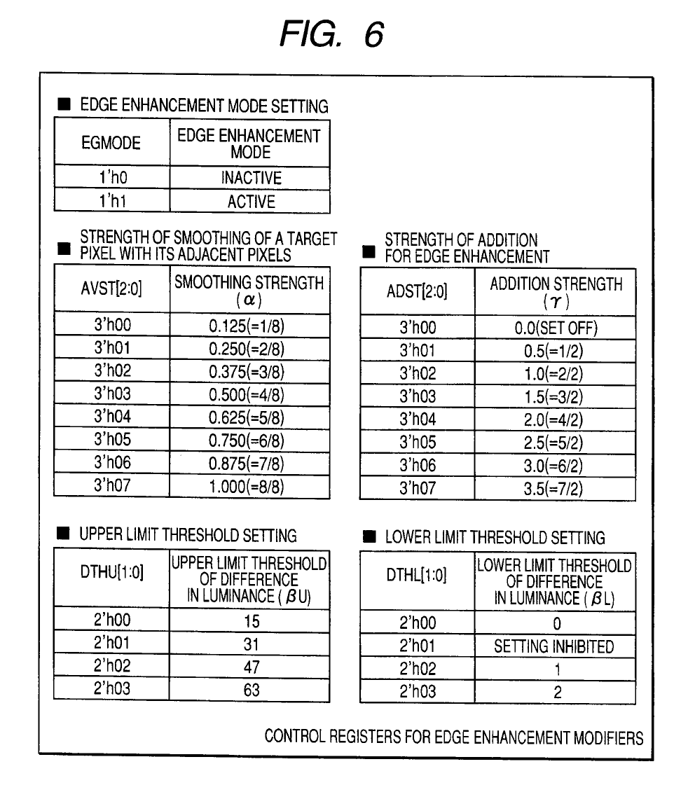

A clock pulse generator (CPG) 60 generates an internal clock automatically and supplies the clock as a reference clock for operation timing to the timing generator 50. An internal reference voltage generating circuit (IVREFG) 61 generates a reference voltage and supplies it to an internal logic power supply regulator (ILOGVG) 62. The internal logic power supply regulator 62 generates a power supply for internal logics, based on the reference voltage.

<<Modification circuit>> FIG. 5 illustrates a principle of how to modify tone values for edge enhancement by the modification circuit 70. FIG. 6 provides a list of the values of the control registers for edge enhancement. Tone modification processing for edge enhancement is enabled when image data is written into the frame buffer in the display data memory 43. Whether modification for edge enhancement is to be performed is determined by a value set in a control register EGMD.

FIG. 5 [i] depicts pixel data tone values in a waveform for convenience sake. PXh to PXk denote data for succeeding pixels. FIG. 5 [ii] depicts a concept of smoothing. If, for example, PXi is a target pixel whose tone is to be modified, the tone value of the pixel PXi is smoothed by using the tone data of its preceding and following pixels PXh, PXj. Likewise, if PXj is a target pixel whose tone is to be modified, the tone value of the pixel PXj is smoothed by using the tone data of its preceding and following pixels PXi, PXk. Smoothing may be executed by simply averaging the tone values of three pixels, whereas the tone values of the target pixel and its preceding and following pixels may be weighted by using a smoothing strength α, as set in a register AVST, before they are averaged. If, for example, the target pixel is PXi, its smoothed tone value is obtained by, for example, α ((PXh(grd)+PXj(grd)+PXi(grd))/3.

FIG. 5 [iii] depicts a concept of differential processing, that is, evaluating a difference between the tone of the original image of the target pixel whose tone is to be modified and the smoothed tone thereof. If the smoothed tone is higher than the tone of the original image, the smoothed tone value is subtracted from the original tone value. If the smoothed tone is lower than the tone of the original image, the smoothed tone value is added to the original tone value. A maximum of and a minimum of differential values obtained by addition and subtraction are determined by an upper limit value βU, as set in a control register DTHU, and a lower limit value βL, as set in a control register DTHL, respectively. A differential value greater than the upper limit value is corrected to the upper limit value and a differential value lower than the lower limit value is corrected to zero.

FIG. 5 [iv] depicts a concept of combining processing, that is, adding the differential value to the tone value of the original pixel image. Herein, an addition strength γ, as set in a register ADST, is used to weight the differential value to be added. The addition strength γ is used as a factor by which the differential value is multiplied.

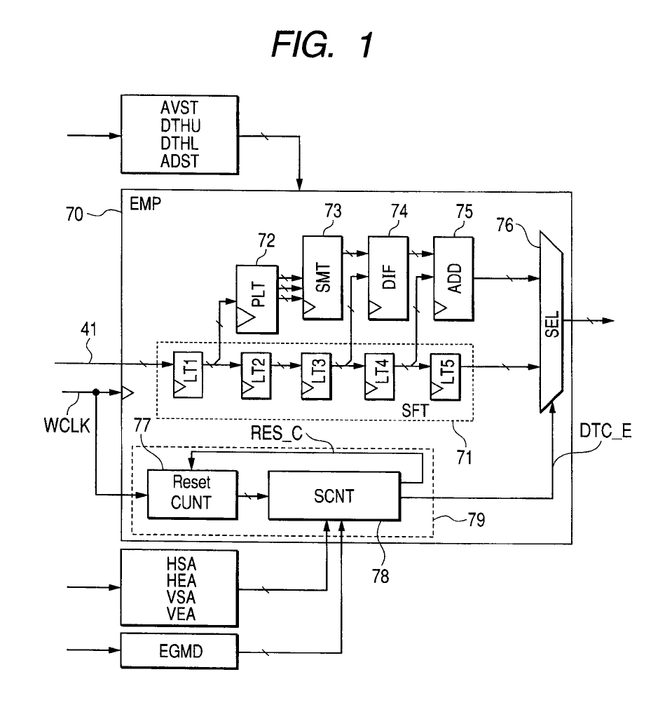

FIG. 1 illustrates an example of the modification circuit 70. For example, one pixel is identified by pixel data consisting of eight bits for each color of R, G and B, a total of 24 bits. Therefore, pixel data may take any combination of 256 tones of the R, G and B colors.

The modification circuit of FIG. 1 is a realization of the principle illustrated in FIG. 5. This circuit is intended to modify the tone value of a focused pixel, using pixel data of the focused pixel and its preceding one pixel and following one pixel. Reference numeral 71 denotes a shift circuit (SFT) consisting of five stages of data latches for pipeline processing. Each stage of shifts LT1 to LT5 is formed by, for example, a master-slave latch circuit that performs a latch operation in sync with a write clock WCLK or a edge triggered pulse latch.

Reference numeral 72 denotes a parallel latch circuit (PLT) for taking in data that can hold pixel data for a focused pixel and its preceding and following pixels, a total of three pixels, in parallel. The parallel latch circuit 72 serially takes in and latches 24-bit pixel data in sync with the write clock WCLK and outputs pixel data for the latest three pixels in parallel. Output of a first stage of latch LT1 in the shift circuit 71 is input to the parallel latch circuit 72, so that the focused pixel data is positioned in the center.

Reference numeral 73 denotes a smoothing circuit (SMT) that performs the above-described smoothing in sync with the write clock WCLK. A smoothing operation is completed in one cycle of the write clock WCLK.

Reference numeral 74 denotes a differential processing circuit (DIF) that completes the above-described differential processing through calculation of a difference between the smoothed tone data and the pixel data focused in the smoothing operation in sync with and in one cycle of the write clock WCLK. The focused pixel data to be modified by differential processing in comparison to the smoothed tone data is input from a third stage of latch (LT3) in the shift circuit 71.

Reference numeral 75 denotes an addition processing circuit (ADD) that completes the above-described addition processing in sync with and in one cycle of the write clock WCLK. The focused pixel data to which the differential data is added in the addition processing is input from a fourth stage of latch (LT4) in the shift circuit 71.

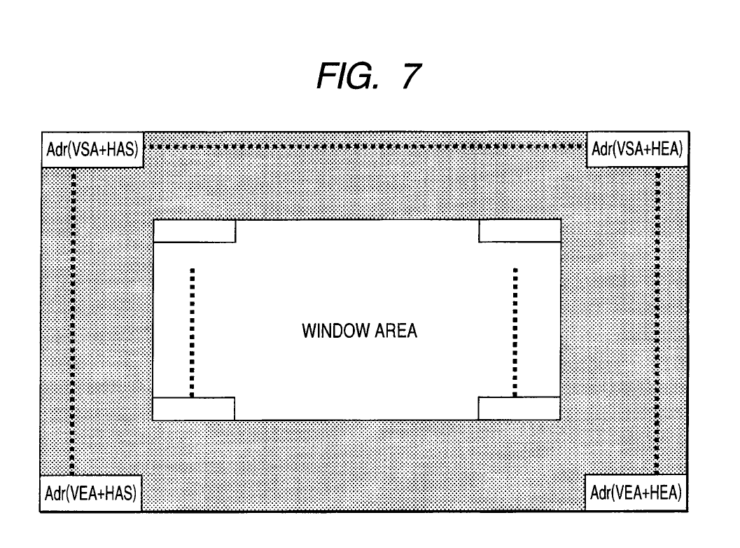

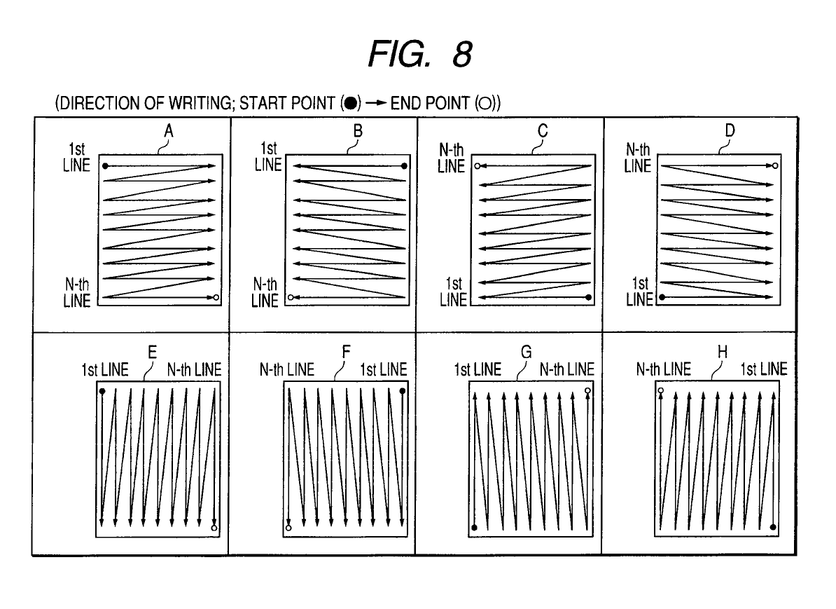

Output of the addition circuit 75 or output of the last stage of latch in the shift circuit 71 is selected by a selector (SEL) 76 and transferred to the write data register 42. The pixel data temporarily stored in the write data register 42 is sequentially written into the frame buffer in the data memory 43. For example, an area of the frame buffer is determined by values set in address registers VSA, VEA, HSA, and HEA. In an address register VSA, a start address in a vertical direction is set. In an address register VEA, an end address in the vertical direction is set. In an address register HSA, a start address in a horizontal direction is set. In an address register HEA, an end address in the horizontal direction is set. The thus determined area of the frame buffer is set up as a rectangular area defined by four fixed points of addresses Adr (VSA+HSA), Adr (VSA+HEA), Adr (VEA+HEA), and Adr (VEA+HSA), as illustrated in FIG. 7. Pixel data that is transferred from the bus 41 to the modification circuit 70 may be, for example, transferred line by line in the horizontal direction from top to bottom in the vertical direction. For example, pixel data is transferred in sequence as depicted in FIG. 8A. When pixel data is transferred to the modification circuit 70 in this sequence, and in a case where a pixel in either end position of each line of transfer is focused for tone modification, data for three pixels is latched into the parallel latch circuit 72 in the following state: a pixel existing on another line of transfer is positioned preceding or following the focused pixel. If, using parallel output of the parallel latch circuit 72 in this state, a smoothing operation is performed, its result is not suitable for being used for pixel edge enhancement. This is because edge enhancement is performed on the pixel existing on one line of transfer, using the data of the pixels placed over two lines of transfer. Taking this into consideration, for a pixel in either end position of a line of pixel data transfer, the data of the pixel in either end position of the line of transfer is selected as is and transferred to the following stage without using the unsuitable result of tone modification obtained from the addition processing circuit 75. The image quality of the original image does not deteriorate. This selection is performed by the selector 76 and its control is performed by a selection control circuit 79 comprising a counter (count) 77 and a control logic (SCNT) 78.

The counter 77 counts pulses of the write clock WCLK and supplies the clock count to the control logic 78. The control logic 78 takes inputs of values set in the registers HSA, HEA, VSA, and VEA and knows the size of the frame buffer. When transfer of write data starts in sync with the write clock WCLK, the counter 77 starts to count clock pulses. Upon the clock count 5 equaling the number of stages of shift in the shift circuit, the counter 77 is reset to 0 by the control logic 78. Subsequently, each time the counter has counted clock pulses equaling the number of pixels existing on one line of transfer in the horizontal direction, the counter is reset to 0 by the control logic 78. RES_C is a reset signal to the counter 77. When the control logic 78 judges the beginning of each line of transfer from the clock count, it causes the selector 76 to select the output of the last stage in the shift circuit 71 for the period of one clock cycle. Likewise, when the control logic judges the termination of each line of transfer from the clock count, it causes the selector 76 to select the output of the last stage in the shift circuit 71 for the period of one clock cycle. In other words, the selection control circuit (SCNT) 77 causes the selector 76 to select the output of the last shift stage in the shift circuit 71 for the period when the arithmetic circuit 75 outputs the result of modification using the pixel data latched in the parallel latch circuit 72 for pixels not placed on a same line in the transfer direction depending on the display size. DTC_E is a selection control signal causing the selector 76 to select the output of the last stage in the shift circuit 71 when its level is high. When edge enhancement processing is deselected by the setting in the register EGMD, the control logic 79 always causes the selector 76 to select the output of the last stage in the shift circuit 71.

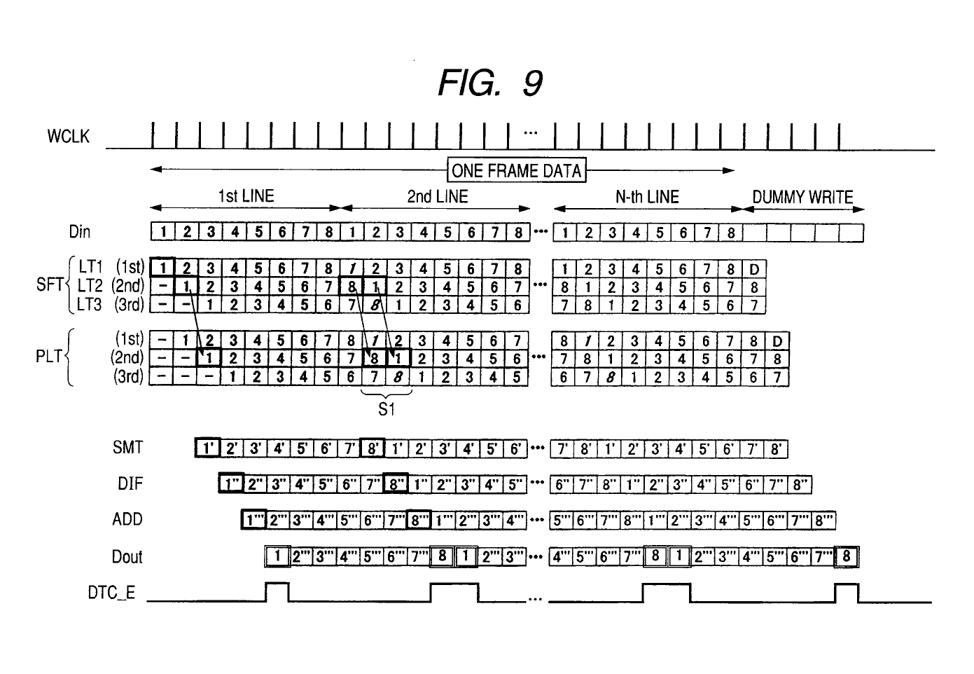

FIG. 9 illustrates an operation timing chart of the modification circuit 70. In the figure, it is assumed that pixel data for eight pixels is placed on one line in the transfer direction. Din is pixel data that is transferred from the bus 41 to the modification circuit. Mark “-” indicates an undefined value. Each data for pixels within each line in the transfer direction is assigned data numbers from 1 to 8. A single apostrophe mark (′) attached to a data number indicates the result of smoothing performed on the focused pixel having the data number. A double apostrophe mark (″) attached to a data number indicates the result of differential processing performed on the focused pixel having the data number. A triple apostrophe mark (′″) attached to a data number indicates the result of addition processing performed on the focused pixel having the data number. Noting at output data Dout of the selector 76, pixel data having data numbers 1, 8 for pixels placed in the end positions of a line of transfer is output as is, whereas pixel data having data numbers 2 to 7 is modified by arithmetic processing and output. Even at a boundary between two lines of transfer, pixel data may be transferred without interruption. This is because, even if pixel data for three pixels is latched in the parallel latch circuit 72 in the state where a pixel preceding or following the focused pixel is placed on another line of transfer (S1 in FIG. 9), the results 1′″ and 8′″ of arithmetic processing as parallel outputs of the parallel latch circuit 72 in this state are not selected as the outputs of the modification circuit 70, as noted above. Consequently, edge enhancement using pixel data for pixels placed over two lines of transfer, having its effect on one of the pixels on one line, does not take place. In comparison with a case where an unsuitable result of tone modification obtained from the addition processing circuit 75 is applied to the pixels in both end positions on a line of transfer of pixel data, the method described herein results in no deterioration in the quality of the original image, even if the data for the pixels in both end positions on the line of transfer is selected as is and transferred to the following stage.

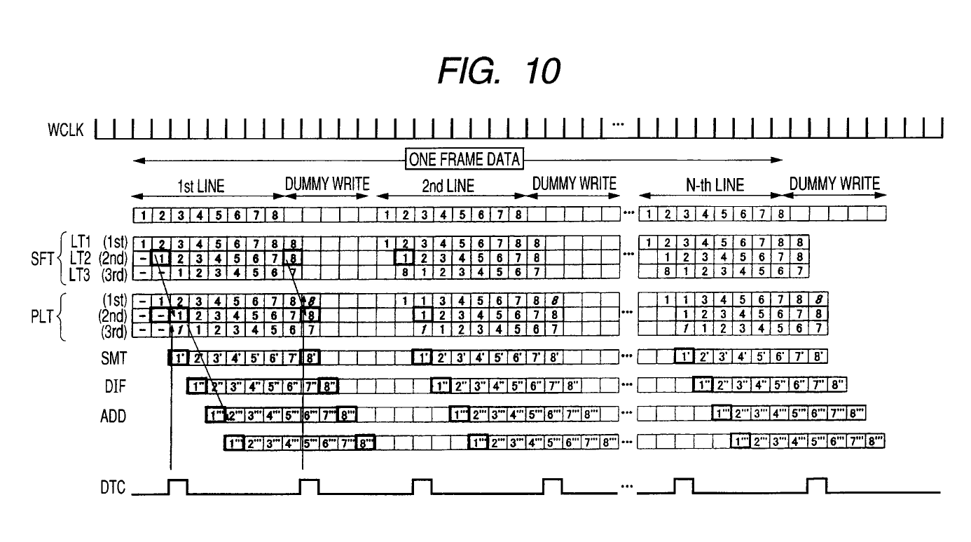

FIG. 10 presents an operation timing chart as a comparison example for a case where the selector 76 in FIG. 1 is not employed to inhibit edge enhancement using pixel data for pixels placed over two lines of transfer. In this case, when second pixel data (data number 2) from the beginning of a line of transfer is input to the parallel latch circuit, first pixel data (data number 1) of the line of transfer, which has already been latched in the parallel latch circuit, is latched doubly in accordance with the trigger of a detection signal DTC that indicates the timing of the double latching of pixel data. Thereby, three pixel data of data numbers 2, 1, 1 is used when smoothing is performed on the first pixel of the line of transfer, which is the focused pixel. Likewise, when last pixel data (data number 8) of a line of transfer is input to the parallel latch circuit as data in the center position, the last pixel data (data number 8) of the line of transfer, which has already been latched in the parallel latch circuit, is latched doubly in accordance with the trigger of the detection signal DTC that indicates the timing of the double latching of pixel data. Thereby, three pixel data of data numbers 7, 8, 8 is used when smoothing is performed on the last pixel of the line of transfer, which is the focused pixel. Since it takes five cycles after the last pixel data of a line of transfer is input to the modification circuit until the result of addition is obtained, five dummy write cycles are required after the input of the last pixel data for each line of transfer in this case. Unless dummy write cycles are inserted, undesirable edge enhancement using pixel data for pixels placed over two lines of transfer, having its effect on one of the pixels on one line, occurs. As for dummy write cycles, in the operational embodiment of FIG. 9, no dummy write cycles need to be inserted, as pixel data can be transferred continuously without a problem. However, because a delay of five clock cycles occurs until processing of the last line of transfer is completed, it is only required to insert dummy write (dummy data write) cycles to compensate for the delay (five cycles) after each frame data is transferred.

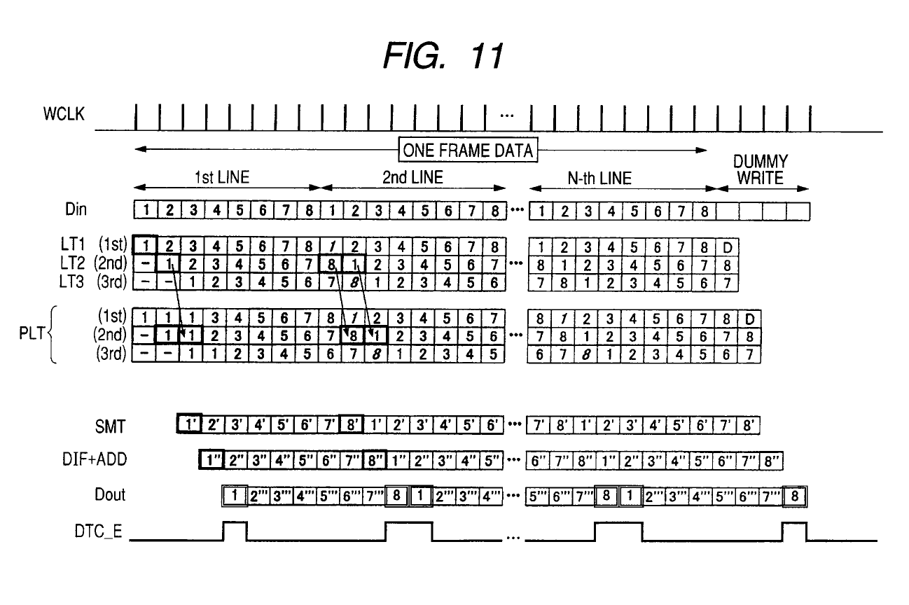

FIG. 11 illustrates an operation timing chart of the modification circuit configured to complete arithmetic processing in two clock cycles. Although the structure of the modification circuit in this operational embodiment is not shown, this can be realized by the differential processing circuit 74 and the addition processing circuit 75, shown in FIG. 1, adapted to perform arithmetic processing in one clock cycle and the shift circuit 71 adapted to employ four stages of latches. Because this shift circuit 71 has four stages of latches, the number of clock cycles until output data Dout is first obtained is one cycle less than the number of cycles in the operational embodiment of FIG. 9. Thus, the number of dummy write cycles to be inserted in the end of a frame is lessened by one cycle. Other operations are the same as described for FIG. 1 and FIG. 9 and, therefore, detailed descriptions thereof are not repeated.

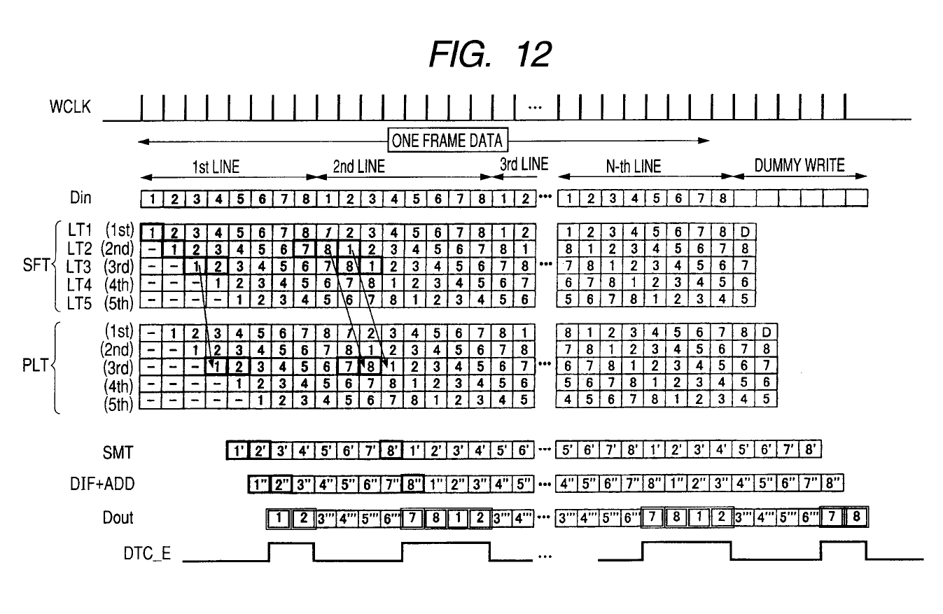

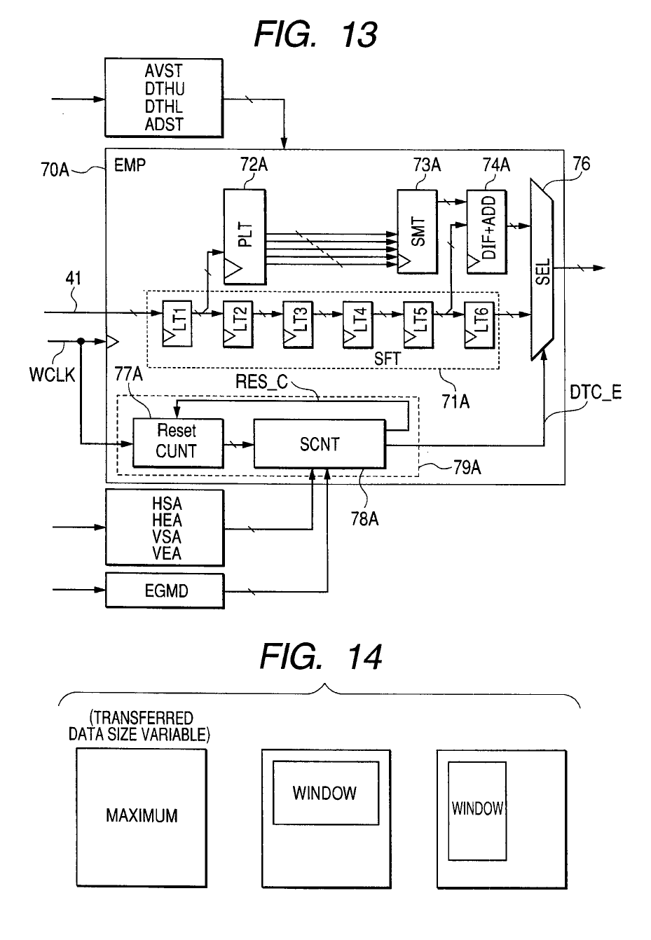

FIG. 12 illustrates an operation timing chart of the modification circuit configured to complete arithmetic processing in two clock cycles and with the parallel latch circuit adapted to latch five pixel data. The structure of the modification circuit in this operational embodiment is illustrated in FIG. 13. As illustrated in FIG. 13, this can be realized as follows: a differential and addition processing circuit 74A performs the arithmetic processing tasks of the differential processing circuit 74 and the addition processing circuit in one clock cycle; and a shift circuit 71A is adapted to employ six stages of latches. Because the shift circuit 71A has six stages of latches, the number of clock cycles until output data Dout is first obtained is one cycle more than the number of cycles in the operational embodiment of FIG. 9. Thus, the number of dummy write cycles to be inserted in the end of a frame is increased by one cycle. Furthermore, a parallel latch circuit 72A latches data for a maximum of five pixels in parallel and a smoothing circuit 73A performs arithmetic processing using the data for a focused pixel and two pixels preceding and two pixels following the focused pixel. A selection control circuit 79A causes the selector 76 to select the first two pixel data from the beginning of a line of transfer and the last two pixel data of the line as is. Other operations are the same as described for FIG. 1 and FIG. 9 and, therefore, detailed descriptions thereof are not repeated.

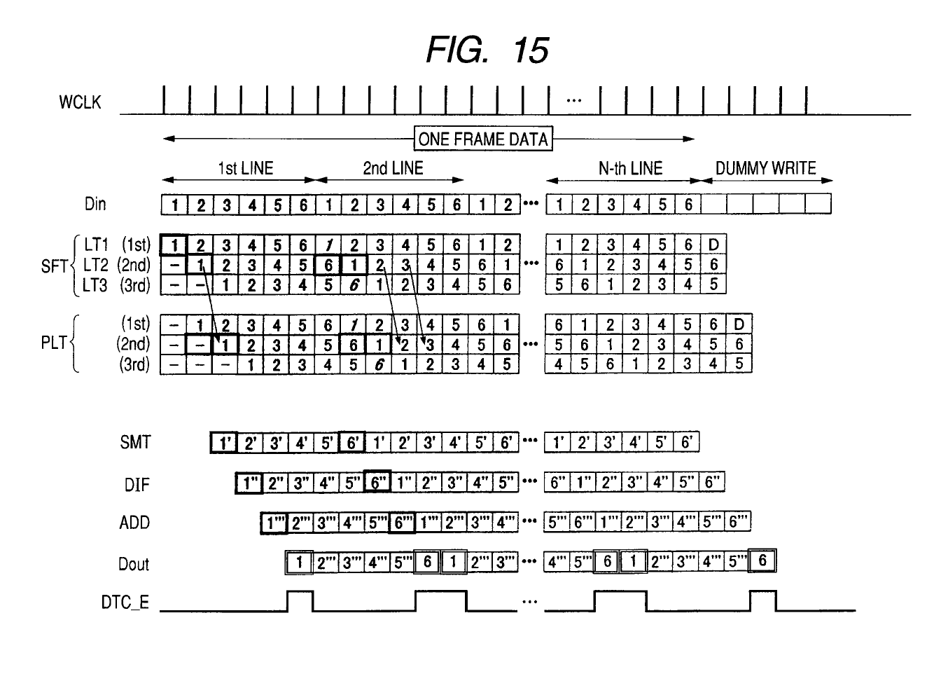

With the registers HSA, HEA, VSA, VEA described for FIG. 1 and other illustrations, addresses may be set to define a partial window area as shown in FIG. 7. Window setup may be placed in any position within a maximum area as illustrated in FIG. 14. FIG. 15 illustrates modification processing timing for data size per line of transfer smaller than in the operational embodiment of FIG. 9. Each line of transfer has data for six pixels in comparison with the operational embodiment of FIG. 9. Other operation timing is the same as described for FIG. 9 and, therefore, detailed description thereof is not repeated.

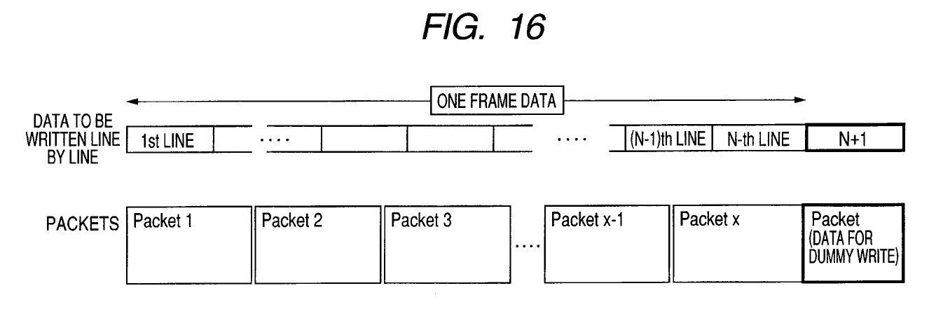

The write clock WCLK may be generated by the high-speed serial interface circuit 25, the parallel interface circuit or the RGB image input interface circuit 26. When the high-speed serial interface circuit 25 is selected for use as the interface with the host device 5, the high-speed serial interface circuit 25 generates the write clock WCLK in response to reception of pixel data packets. As illustrated in FIG. 16, it is needed to add a dummy write data packet required to insert dummy write cycles in the last data packet of image data to be written. When the parallel interface circuit 33 is selected for use as the interface with the host device 5, the parallel interface circuit 33 generates the write clock WCLK in response to level change of a write strobe signal WR, one of parallel interface control signals supplied together with pixel data from the host device 5. In this case also, it is needed to add dummy write cycles in the end of a frame. To insert dummy write cycles in the parallel interface mode, the host device, namely, the MCU 5 must activate a dummy write operation by executing a data transfer command. Since the number of dummy write cycles to be inserted in the operational embodiment of FIG. 9 is much fewer than that number in the case of FIG. 10, the burden of the MCU 5 can be reduced.

When the RGB image input interface circuit 65 inputs the timing control signals for rendering moving image data which is input via the parallel interface circuit 33 into the frame buffer, the RGB image input interface circuit (RGBIF) 65 supplies the dot clock DOTCLK input as the write clock WCLK to the modification circuit 70.

While the present invention has been described specifically based on its illustrative embodiments hereinbefore, it will be appreciated that the present invention is not limited to the described embodiments and various modifications may be made without departing from the gist of the invention.

For example, while writing pixel data into the frame buffer has been described, assuming the direction of writing as shown in FIG. 8A in the above description, the present invention is not so limited and pixel data may be transferred and written in any direction or sequence as shown in FIGS. 8B to 8H. Address mapping within the frame buffer area and the direction of transfer of pixel data may be varied or changed. Accordingly, the counting direction of the counter 77, 77A and the logic of the control logic 79, 79A for detecting the ends of a line of transfer based on the clock count may be changed. The host device is not limited to a single MCU 5 that is used for baseband processing and application processing. Both a baseband processor and an application processor may be host devices. Additionally, the host devices may include another circuit. The present invention can broadly be applied to diverse mobile terminal devices such as mobile data processing terminals and storage terminals like a Personal Digital Assistants (PDA), not limited to mobile phones.

What is claimed is:

1. A display control device including a modification circuit capable of modifying tone values of pixel data sequentially transferred from an external entity in accordance with display size,
said modification circuit comprising:
a shift circuit having a plurality of stages for shifting sequentially transferred pixel data in sync with an operational clock;
a parallel latch circuit for latching in parallel shift outputs for a plurality of serial pixels of pixel data passing through said shift circuit;
an arithmetic circuit for arithmetic processing using the pixel data for the serial pixels latched in said parallel latch circuit, while synchronizing with shift actions of said shift circuit, and modifying an intermediate shift output of said shift circuit according to the arithmetic processing result;
a selector for selecting output of a last shift stage of said shift circuit or output of said arithmetic circuit; and
a selection control circuit allowing said selector to select the output of the last shift stage of said shift circuit for a period when a result of modification is obtained by said modification circuit, using the pixel data latched in said parallel latch circuit for pixels not placed on a same line in a transfer direction depending on said display size.

2. The display control device according to claim 1, wherein, when said parallel latch circuit is configured to latch pixel data for a maximum of three pixels, said selection control circuit causes said selector to select pixel data for a pixel in an end position of a line in the transfer direction depending on the display size from the last shift stage of said shift circuit.

3. The display control device according to claim 1, wherein, when said parallel latch circuit is configured to latch pixel data for a maximum of five pixels, said selection control circuit causes said selector to select pixel data for a pixel in an end position and its neighboring pixel on a line in the transfer direction depending on the display size from the last shift stage of said shift circuit.

4. The display control device according to claim 1, further comprising a first control register for specifying said display size in vertical and horizontal directions,
wherein said selection control circuit judges the end pixel position in the transfer direction depending on the display size, based on values set in said first control register.

5. The display control device according to claim 4, wherein said arithmetic circuit performs: first arithmetic processing for smoothing the pixel data for the serial pixels latched in said parallel latch circuit; second arithmetic processing for calculating differential data from a difference between smoothed data and pixel data obtained from an intermediate shift output of said shift circuit; and third arithmetic processing for adding said differential data to pixel data obtained from a next-stage intermediate shift output of said shift circuit.

6. The display control device according to claim 5,
wherein said shift circuit comprises five serial shift stages,
wherein said parallel latch circuit latches in parallel serial intermediate shift outputs of a first shift stage of said shift circuit for three cycles of the operational clock, and
wherein said arithmetic circuit comprises a first arithmetic processing circuit which takes parallel inputs of the pixel data for three pixels latched in the parallel latch circuit and performs said first arithmetic processing in one cycle of said operational clock, a second arithmetic circuit which receives output of said first arithmetic processing circuit and an intermediate shift output of a third shift stage of said shift circuit and performs said second arithmetic processing in one cycle of said operational clock, and a third arithmetic circuit which receives output of said second arithmetic processing circuit and an intermediate shift output of a fourth shift stage of said shift circuit and performs said third arithmetic processing in one cycle of said operational clock.

7. The display control device according to claim 6, wherein said selection control circuit causes said selector to select output of the last shift stage of said shift circuit for pixel data in an end pixel position in the transfer direction depending on the display size and causes the selector to select output of said third arithmetic circuit for other pixel positions.

8. The display control device according to claim 5, further comprising a second control register, wherein weighting that is applied to pixel data that is used for smoothing is determined depending on a value set in the second control register.

9. The display control device according to claim 5, further comprising a third control register, wherein an upper limit and a lower limit of a difference that is used to obtain differential data are determined depending on values set in the third control register.

10. The display control device according to claim 5, further comprising a fourth control register, wherein weighting that is applied to differential data to be added is determined depending on a value set in the fourth control register.

11. A semiconductor integrated circuit comprising:
external terminals for host interface;
a host interface circuit coupled to said external terminals for host interface; a display control circuit coupled to said host interface circuit; and
external terminals for display drive coupled to said display control circuit,
wherein said host interface circuit comprises at least one of a first serial interface circuit for serial data input and output in a differential manner, a parallel interface circuit, and any other interface circuit, in which an interface circuit is selected for use as the interface with a host device according to a host interface mode setting state,
wherein said display control circuit comprises: a display data memory capable to be used as a frame buffer of display data; and a modification circuit capable of modifying tone values of pixel data to be stored in said display data memory,
said modification circuit comprises: a shift circuit having a plurality of stages for shifting pixel data sequentially transferred from said host interface circuit in accordance with display size in sync with an operational clock; a parallel latch circuit for latching in parallel shift outputs for a plurality of serial pixels of pixel data passing through said shift circuit; an arithmetic circuit for arithmetic processing using the pixel data for the serial pixels latched in said parallel latch circuit, while synchronizing with shift actions of said shift circuit, and modifying an intermediate shift output of said shift circuit according to the arithmetic processing result; a selector for selecting output of a last shift stage of said shift circuit or output of said arithmetic circuit; and a selection control circuit allowing said selector to select the output of the last shift stage of said shift circuit for a period when a result of modification is obtained by said modification circuit, using the pixel data latched in said parallel latch circuit for pixels not placed on a same line in a transfer direction depending on said display size.

12. The semiconductor integrated circuit according to claim 11,
wherein said host interface circuit comprises said first serial interface circuit, said first serial interface circuit,
wherein when selected for use as the interface with said host device, said first serial interface circuit generates said operational clock in response to reception of pixel data packets, and
wherein a data packet having dummy data written is added in the end of a series of said data packets for one frame.

13. The semiconductor integrated circuit according to claim 11,
wherein said host interface circuit comprises said parallel interface circuit and said parallel interface circuit, and
wherein when selected for use as the interface with said host device, said parallel interface circuit generates said operational clock in response to level change of a write strobe signal which is one of parallel interface control signals supplied together with pixel data externally of the semiconductor integrated circuit.

14. The semiconductor integrated circuit according to claim 11,
wherein said host interface circuit comprises said any other interface circuit and said parallel interface circuit, and includes as said any other interface circuit an RGB image input interface circuit for inputting timing control signals for rendering data that is input via said parallel interface into the frame buffer,
wherein said host interface circuit inputs as said timing control signals a data enable signal which indicates that valid data is present, a horizontal synchronization signal, a vertical synchronization signal, and a dot clock which specifies timing for taking in data, and
wherein said RGB image input interface circuit supplies said dot clock input as said operational clock to said modification circuit.

15. A mobile terminal device comprising: a first casing half; and a second casing half foldably coupled to said first casing half via a hinge member,
wherein said first casing half comprises a host device,
wherein said second casing half comprises a liquid crystal display drive controller interfaced with said host device via a plurality of signal lines and a liquid crystal display whose display operation is controlled by said liquid crystal display drive controller,
wherein said signal lines go through said hinge member,
wherein said liquid crystal display drive controller is formed of a semiconductor integrated circuit which comprises: external terminals for host interface; a host interface circuit coupled to said external terminals for host interface; a display control circuit coupled to said host interface circuit; and external terminals for display drive coupled to said display control circuit,
wherein said host interface circuit comprises: a first serial interface circuit for serial data input and output in a differential manner; a parallel interface circuit; and any other interface circuit,
wherein an interface circuit is selected for use as the interface with the host device according to a host interface mode setting state,
wherein said display control circuit comprises: a display data memory capable to be used as a frame buffer of display data; and a modification circuit capable of modifying tone values of pixel data to be stored in said display data memory, and
wherein said modification circuit comprises: a shift circuit having a plurality of stages for shifting pixel data sequentially transferred from said host interface circuit in accordance with display size in sync with an operational clock; a parallel latch circuit for latching in parallel shift outputs for a plurality of serial pixels of pixel data passing through said shift circuit; an arithmetic circuit for arithmetic processing using the pixel data for the serial pixels latched in said parallel latch circuit, while synchronizing with shift actions of said shift circuit, and modifying an intermediate shift output of said shift circuit according to the arithmetic processing result; a selector for selecting output of a last shift stage of said shift circuit or output of said arithmetic circuit; and a selector allowing selection of the output of the last shift stage of said shift circuit for a period when a result of modification is obtained by said modification circuit, using the pixel data latched in said parallel latch circuit for pixels not placed on a same line in a transfer direction depending on said display size.

16. The mobile terminal device according to claim 15,
wherein said first serial interface circuit, when selected for use as the interface with said host device, generates said operational clock in response to reception of pixel data packets, and
wherein a data packet having dummy data written is added in the end of a series of said data packets for one frame.

17. The mobile terminal device according to claim 15, wherein said parallel interface circuit, when selected for use as the interface with said host device, generates said operational clock in response to level change of a write strobe signal which is one of parallel interface control signals supplied together with pixel data from said host device.

18. The mobile terminal device according to claim 15,
wherein said any other interface circuit comprises an RGB image input interface circuit for inputting timing control signals for rendering data that is input via said parallel interface into the frame buffer,
wherein as said timing control signals, a data enable signal which indicates that valid data is present, a horizontal synchronization signal, a vertical synchronization signal, and a dot clock which specifies timing for taking in data are inputted, and
wherein said RGB image input interface circuit supplies said dot clock input as said operational clock to said modification circuit.
